(19) United States
(12) Patent Application Publication
(10) Pub. No.: US 2025/0272103 A1
(43) Pub. Date: Aug. 28, 2025

(54) SPECULATION THROTTLING

(71) Applicant: Arm Limited, Cambridge (GB)

(72) Inventors: Dam SUNWOO, Austin, TX (US); Chris ABERNATHY, Austin, TX (US); Matthew Paul ELWOOD, Austin, TX (US); Michael Brian SCHINZLER, Round Rock, TX (US); William Elton BURKY, Austin, TX (US); Houdhaifa BOUZGUARROU, Austin, TX (US); Chang Joo LEE, Austin, TX (US)

(21) Appl. No.: 18/589,892

(22) Filed: Feb. 28, 2024

(51) Int. Cl. G06F 9/38

(52) U.S. Cl. CPC G06F 9/3842

(57) ABSTRACT

A data processing apparatus includes execution circuitry that executes a plurality of instructions using speculation. Throttle circuitry throttles an extent to which the speculation is performed and the throttle circuitry controls throttling speculation based on an availability of the instructions.

### TECHNICAL FIELD

The present disclosure relates to data processing and particularly speculative execution.

### DESCRIPTION

Speculative execution makes it possible to continue executing when there is uncertainty as to what execution is to be performed. An example of this is control flow speculation or branch prediction that causes execution to proceed down one direction of a branch when a branch instruction is encountered. An error in speculation (misprediction) causes a rewind to occur. Speculation can therefore increase performance but misprediction means that energy is consumed unnecessarily. It is therefore undesirable to speculate when the cost (or potential risk) is perceived to be high.

### SUMMARY

Viewed from a first example configuration, there is provided a data processing apparatus comprising: execution circuitry configured to execute a plurality of instructions using speculation; and throttle circuitry configured to throttle an extent to which the speculation is performed, wherein the throttle circuitry is configured to control throttling speculation based on an availability of the instructions.

Viewed from a second example configuration, there is provided a method comprising: executing a plurality of instructions using speculation; and controlling throttling of speculation, wherein the controlling is based on an availability of the instructions.

Viewed from a third example configuration, there is provided a non-transitory computer-readable medium storing computer-readable code for fabrication of a data processing apparatus comprising: execution circuitry configured to execute a plurality of instructions using speculation; and throttle circuitry configured to throttle an extent to which the speculation is performed, wherein the throttle circuitry is configured to control throttling speculation based on an availability of the instructions.

Viewed from a fourth example configuration, there is provided a system comprising: the data processing apparatus implemented in at least one packaged chip; at least one system component; and a board, wherein the at least one packaged chip and the at least one system component are assembled on the board.

### BRIEF DESCRIPTION OF THE DRAWINGS

The present invention will be described further, by way of example only, with reference to embodiments thereof as illustrated in the accompanying drawings, in which:

FIG. 1 schematically illustrates an example of a data processing apparatus;

FIG. 2 illustrates how speculative execution can occur;

FIG. 3 shows an example of a decode queue;

FIG. 4 shows a further example of how the occupancy of the decode queue controls which policy to use;

FIG. 5 illustrates a flowchart that shows a method of applying the throttle policy in accordance with some examples;

FIG. 6 shows examples of where throttling might take place;

FIG. 7 illustrates a flow chart in accordance with some examples;

FIG. 8 illustrates an example of an apparatus comprising a processing element comprising execution circuitry for executing processing operations in response to decoded program instructions;

FIG. 9 illustrates an example of a vector datapath that may be provided as part of the execution circuitry of the processing element, and vector registers for storing vector operands for processing by the vector datapath; and

FIG. 10 shows one or more packaged chips, with the apparatus implemented on one chip or distributed over two or more of the chips.

### DESCRIPTION OF EXAMPLE EMBODIMENTS

Before discussing the embodiments with reference to the accompanying figures, the following description of embodiments is provided.

In accordance with one example configuration there is provided a data processing apparatus comprising: execution circuitry configured to execute a plurality of instructions using speculation; and throttle circuitry configured to throttle an extent to which the speculation is performed, wherein the throttle circuitry is configured to control throttling speculation based on an availability of the instructions.

The speculation could, for instance be control-flow speculation based on branch prediction. Such speculation is often used in order to predict the direction that a branch will take so that the pipeline can continue to fetch, decode, and potentially execute instructions down one particular path of the branch prior to the branch instruction being resolved. This saves the data processing apparatus/pipeline from stalling when a branch is encountered. Errors in the prediction can be resolved by a ‘rewind’. The throttling that occurs controls the speculation and reduces the extent to which it is performed. In particular, a particular speculation throttling policy is put into effect that controls when speculation can occur. The throttling policy that is selected is selected based on availability of the instructions. That is to say that a plurality of throttling policies exist and the one that is selected depends on the instruction availability. The availability of the instructions could be measured based on the availability of the instructions to the execution circuitry or could be assessed based on whether instructions can be easily fetched and/or decoded. The inventors of the present technique have discovered that controlling the extent of speculation based on the availability of instructions provides a good balance between the potential performance gains that can be achieved using speculative execution and the energy consumption caused through unnecessary (or potentially unnecessary speculation).

In some examples, the availability of the instructions is determined according to an occupancy of a decode queue by the instructions. A decode queue can contain, for instance, the contents of instructions of a program that have been fetched from memory and are waiting to be decoded in order to produce a set of control signals corresponding to the memory. In general, it may be possible to fetch instructions more quickly than they can be decoded (although the rate of instruction fetching can vary) and so a queue is provided so that the fetched instructions can await decoding in, for instance, a decode stage of the pipeline. Note that the decode queue occupancy need not be an instantaneous occupancy and in some embodiments, the occupancy is determined as an average occupancy over a number of processor cycles.

In some examples, the throttle circuitry is configured to throttle speculation more aggressively when the availability of the instructions is above an availability threshold as compared to when the availability of the instructions is below the availability threshold. A more aggressive throttling of speculation means that speculation occurs less readily or less often, for instance. In these examples, when instructions have increased availability, i.e. when the supply of instructions is high, then causing speculation to occur less often will have little effect on performance. In contrast, when the instruction supply is suffering and there is a reduced availability of instructions, speculation should occur in order to increase the instruction supply.

In some examples, the throttle circuitry is configured to throttle speculation by selection of a speculation throttling policy. Rather than directly controlling how much speculation is permitted, it is possible to control the policy that is used. The policy may have its own criteria as to how much throttling can take place. In some examples, however, the policy overall may be seen as having more aggressive throttling when the instruction supply is high. In these examples, a more aggressive policy may be one that more readily throttles speculation or applies a higher average level of throttling when comparing similar scenarios.

In some examples, the speculation throttling policy causes throttling based on an estimated probability that a current in-flight control flow instruction in the instructions has been mispredicted based on a number of in-flight control flow instructions in the instructions and a current prediction success rate of control flow instructions in the instructions. The throttling performed by the policy may be determined based on a probability that there is a current in-flight (unresolved) control flow instruction that has been mispredicted. This could be based on a number of in-flight control flow instructions and a probability with which one of those instructions has been mispredicted. The latter statistic can be determined over a number of previous control flow instructions and the general success rate of prediction rather than a predicted success rate for that specific instruction (although such an approach can also be used).

In some examples, the current prediction success rate of control flow instructions in the instructions is the current prediction success rate of low-confidence control flow instructions in the instructions. Rather than considering statistics for all control flow instructions, the statistics may be determined for instructions that are considered to be ‘low-confidence’. Such instructions can be considered to be those instructions for which the confidence is neither certain nor as high as can be expressed, for instance.

In some examples, the low confidence control flow instructions comprise those for which the following conditions are met: conditional control flow instructions whose confidence metric is unsaturated, control flow instructions that are predicted dynamically, and conditional control flow instructions that are predicted. Thus, a conditional control flow instruction whose confidence metric is saturated (i.e. for which the confidence is as high as can go) are considered to be ‘high’ confidence instructions. Similarly, ‘high’ confidence instructions include those for which prediction occurs statically by analysis of the instruction. This would include unconditional branch instructions for instance. Finally, high confidence control flow instructions include conditional control flow instructions for which no prediction has been made. Such instructions may never have been seen before but also include instructions that have been seen before and are considered to be never taken (e.g. since branch predictors typically only store data for branches that are taken).

In some examples, the speculation throttling policy causes throttling to increase when a likelihood that the current in-flight control flow instruction in the instructions has been mispredicted is above a misprediction threshold. The misprediction threshold can therefore be used to control when throttling occurs and the extent to which throttling occurs.

In some examples, the throttle circuitry is configured to throttle the extent to which the speculation is performed by stalling a single point of a pipeline comprising the processing circuitry. A point of a pipeline could be considered to be a stage such as the fetch stage, the decode stage, the rename stage, the issue stage, the execute stage, or the writeback stage. Here, a stage represents a particular process in the pipeline through which each instruction goes, that can be executed in parallel with another stage that might operate on another instruction. The point in a pipeline could also be a specific part or sub-step within that stage. For example, it could form the branch prediction that occurs during the fetch stage of the pipeline. A point in the pipeline could also be a number of contiguous stages. For instance, in a typical simplified pipeline, the point in the pipeline could be the fetch and decode stages.

In some examples, the single point is a rename stage of the pipeline. During the rename stage, logical registers used in program instructions are mapped on to physical registers that represent the actual underlying hardware. Stalls may naturally happen at this stage due to insufficient physical resource being available. For instance, if a very large number of instructions can be in-flight simultaneously then lots of physical registers may be assigned so as to minimise the effect of a rewind should one be necessary. Consequently, if no physical registers are available then the rename stage may stall. The exact method by which a stall is achieved is beyond the scope of this disclosure. However, one way in which the rename stage can be stalled would be to insert a number of ‘bubbles’ or ‘dummy’ instructions into the rename stage in order to use up physical resources and cause a stall until some of the in-flight instructions are resolved and thereby give up the right to use their assigned physical resource. This itself limits speculation by preventing a branch from being followed further until previous instructions (e.g. previous control flow instructions) are resolved and not rewound.

In some examples, the single point is a branch prediction stage of the pipeline. During branch prediction, a prediction is made as to whether a control flow instruction should be taken or not taken, and instructions will continue to be fetched along the predicted path as required. Stalling can take place by merely shutting off the branch predictor. Thus, instructions can continue to be executed until a branch prediction needs to take place and thus, the likelihood of a misprediction would increase again.

In some examples, the throttle circuitry is configured to throttle the extent to which the speculation is performed by stalling multiple points of a pipeline comprising the processing circuitry. Rather than stalling a single point, it is possible to stall multiple points-such as the branch predictor and the rename stage. This can increase the energy savings that occur by deactivating multiple points of the pipeline, but it can also have a bigger impact on performance due to fewer parts of the pipeline operating.

In some examples, the multiple points are between a branch prediction stage of the pipeline and a rename stage of the pipeline, inclusive. That is to say that all of the pipeline from the branch prediction stage to the rename stage can be stalled. Note that this does not stall the execute stage and so instructions can continue to be executed so that in-flight instructions are able to resolve.

In some examples, the throttle circuitry is configured to throttle speculation additionally based on a type of predictor used for the speculation being performed. An additional parameter that can be considered for the throttling is the type of predictor (e.g. branch predictor) being used. There are many such branch predictors and indeed, modern systems may use a number of different branch predictors in parallel to perform branch prediction. Each branch predictor may have a number of characteristics in terms of accuracy, reliability, and power consumption and such parameters may factor into whether and the extent to which throttling is performed.

In some examples, the throttle circuitry is configured to throttle speculation additionally based on an extent to which a replay predictor is used for the speculation. Replay predictors recognise that when speculation occurs and a rewind is performed that many of the instructions that are performed before the rewind may occur again. In that case, it may be undesirable to ‘lose’ the processing that has been performed and require it to take place a second time. In these examples, if a replay predictor is used then this may control the extent to which throttling occurs. For instance, since the cost of a rewind is ameliorated by virtue of replay being possible, the use of a replay predictor may make throttling less likely or less extensive. Here, the use of the replay predictor can be ascertained in a variety of ways. For instance, the replay predictor might be considered to be in effect if it has been active over the last L cycles, instructions, or control flow instructions or if it has been used as the basis for the prediction of the current instruction.

In some examples, the data processing apparatus comprises: control circuitry configured to selectively control the throttle circuitry to enter a static mode of operation in which the throttle circuitry is configured to control throttling speculation regardless of the availability of the instructions. Thus, in these examples, the throttling can be deactivated or can be set to a static policy in which regardless of how available the instructions are, throttling is deactivated or is based on some other parameter. This may be appropriate in a situation where performance is desired, even at the cost of increased energy consumption. The control circuitry can be used to switch between the modes dynamically, e.g. at runtime, or can be switched when the device powers on. In some examples, the control circuitry requires a particular key or hardware modification in order to be switched between the modes.

In some examples, the throttle circuitry is configured to control throttling speculation additionally based on a number of the instructions that have been executed speculatively divided by a number of retired instructions.

Particular embodiments will now be described with reference to the figures.

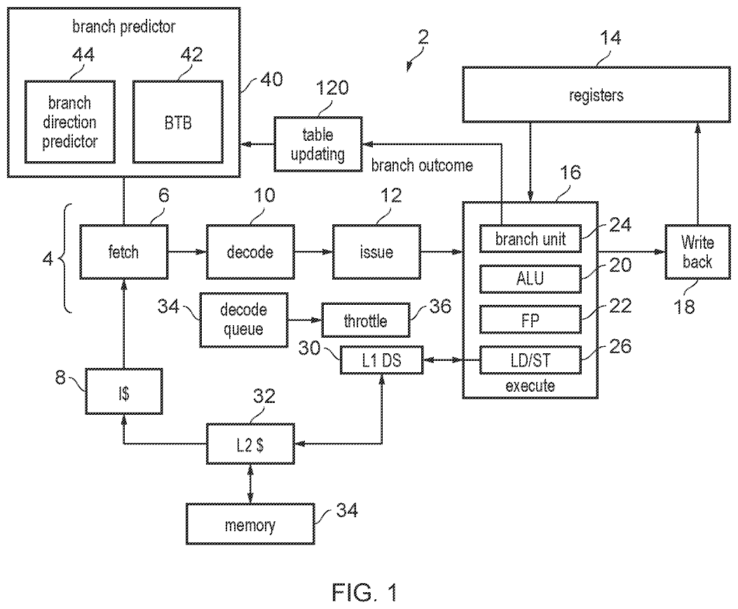

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8 into a decode queue 34; a decode stage 10 for decoding the fetched program instructions in the decode queue 34 to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

As shown in FIG. 1, the apparatus 2 includes a branch predictor 40 for predicting outcomes of branch instructions. The branch predictor is looked up based on addresses of instructions provided by the fetch stage 6 and provides a prediction on whether those instructions are predicted to include branch instructions, and for any predicted branch instructions, a prediction of their branch properties such as a branch type, branch target address and branch direction (predicted branch outcome, indicating whether the branch is predicted to be taken or not taken). The branch predictor 40 includes a branch target buffer (BTB) 42 for predicting properties of the branches other than branch direction, and a branch direction predictor (BDP) 44 for predicting the not taken/taken outcome (branch direction). It will be appreciated that the branch predictor could also include other prediction structures such as a call-return stack for predicting return addresses of function calls, a loop direction predictor for predicting when a loop controlling instruction will terminate a loop, or other more specialised types of branch prediction structures for predicting behaviour of outcomes in specific scenarios.

As shown in FIG. 1, the apparatus 2 may have table updating circuitry 120 which receives signals from the branch unit 24 indicating the actual branch outcome of instructions, such as indications of whether a taken branch was detected in a given block of instructions, and if so the detected branch type, target address or other properties. If a branch was detected to be not taken then this is also provided to the table updating circuitry 120. The table updating circuitry 120 then updates state within the BTB 42, the branch direction predictor 44 and other branch prediction structures to take account of the actual results seen for an executed block of instructions, so that it is more likely that on encountering the same block of instructions again then a correct prediction can be made.

The branch predictor 40 makes it possible for speculative execution to occur. That is, when a branch or control flow instruction is encountered, rather than waiting for the branch to resolve to determine where instructions should continue to be fetched from, a prediction is made and one particular ‘path’ is taken. Instructions continue to be fetched, decoded, and executed from that path. When the branch instruction is finally resolved, either the prediction was correct (in which case a stall was averted) or the prediction was incorrect, in which case a ‘flush’ must occur to rewind processing back to the point of the branch instruction. In general, however, such a rewind effectively means that no processing has been performed and so on average, the performance is improved.

In these examples, throttle circuitry 36 is provided in order to throttle the extent to which such speculation can occur. This is based on an availability of instructions. In particular, it is based on an occupancy of the decode queue 34.

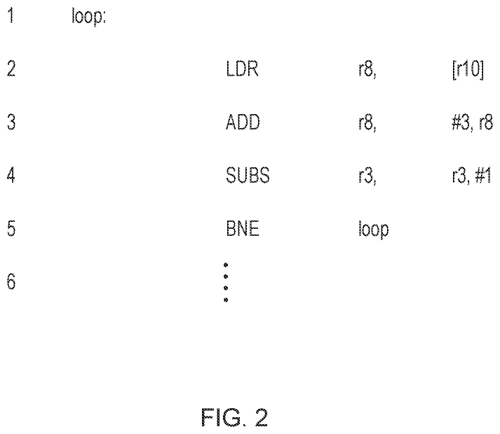

FIG. 2 illustrates how speculative execution can occur. In FIG. 2 is a simple loop that starts at the tag ‘loop:’ on line 1. On line 2, the address stored in register r10 is accessed and the contents stored in register r2. Line 3 then adds the value ‘3’ to the value in register r8 and stores the result in register r8. Line 4 then decrements a counter stored in register r3 by 1. This is the ‘for’ loop iterator. Then, line 5 determines whether the branch is zero and returns to loop if not. The rest of the program proceeds after line 6, i.e. if the counter reaches 0.

Each time the BNE instruction is encountered on line 5, it is unknown whether a branch will occur or not until such time as the SUBS instruction on line 5 has resolved. In practice, there may be several processor cycles between the SUBS instruction being fetched and it being resolved. Without speculation, it would be necessary to stall the pipeline at this stage until it is known whether to continue fetching next instructions from line 6 or from line 1 (depending on whether the branch is taken or not taken, respectively).

With speculation, a prediction is made as to whether the branch will be taken or not. There are a number of different branch predictors available, and the workings of such predictors is beyond the scope of this disclosure. Nevertheless, whichever way the prediction is made, instructions will be fetched (and subsequently decoded, etc.) from the specified path. That is, if it is predicted that the branch will be taken, then instructions will continue to be fetched, decoded, and so on from line 1 rather than from line 6. This makes it possible to avoid stalling the pipeline. If the prediction is correct then no further action needs to be taken. If the prediction is incorrect (e.g. if when SUBS is decoded, it is determined that the wrong prediction was made) then a rewind occurs. Execution that took place after the mispredicted instruction is undone and instruction restarts following the correct path.

Note that it is possible for multiple levels of speculation to occur. For instance, the SUBS instruction could be reached on a second iteration through the loop before resolution of the SUBS instruction in the first iteration has occurred. This therefore results in multiple layers of speculation occurring. It will be appreciated that, in general, the deeper the speculation goes (e.g. the more times a prediction has had to be made) the less likely it is that the taken path will be the correct path since it will be necessary for every previous in-flight control flow instruction to have been predicted correctly in order for the current path to be correct.

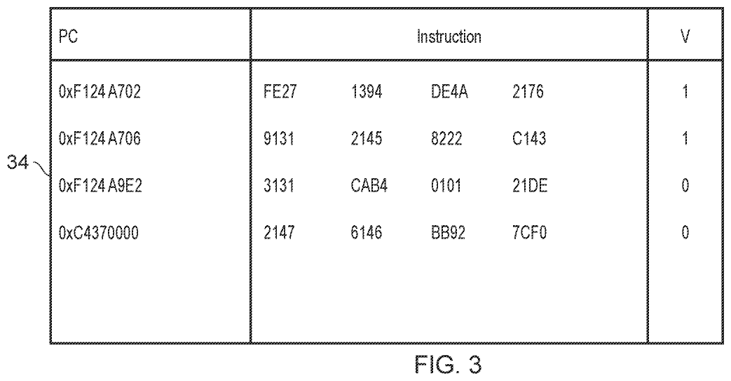

FIG. 3 shows an example of a decode queue 34. As previously discussed, the present technique uses an availability of instructions (e.g. as available in the decode queue 34) to control throttling of speculation.

In the present example, each entry in the decode queue 34 contains a program counter (PC) value, which is a value of the program counter at which a particular instruction was encountered. The entry also contains the instruction itself, which consists of an encoded form of the instruction itself. Finally, a validity flag (V) indicates whether the entry is valid or not. When an instruction is inserted into the decode queue 34, its validity flag is marked as being valid (e.g. 1). Once that instruction is passed to the decode stage 10 in order to generate micro operations, the entry is marked as invalid (e.g. 0). Although one may consider invalid entries to be ‘empty’ technically no deletion of the entry occurs for efficiency purposes. Instead, a single validity bit is flipped.

The present technique can increase the throttling that occurs as the occupancy increases. This can either be a direct relationship, or it can be achieved by implementing a more aggressive throttling policy, which applies its own criteria as to when throttling occurs and the extent to which it occurs.

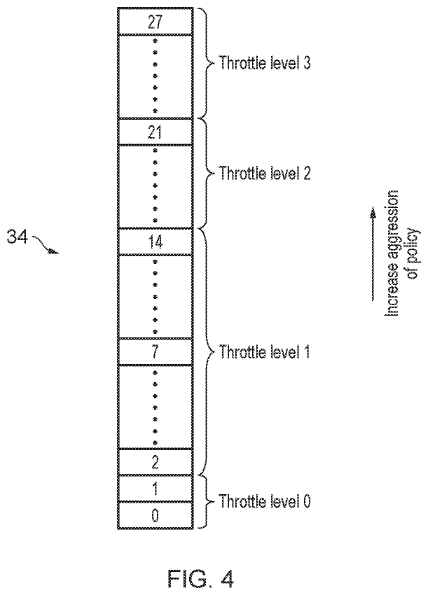

FIG. 4 shows a further example of how the occupancy of the decode queue 34 controls which policy to use. In this example, when the decode queue 34 has 0 or 1 valid entries, a throttling level/policy 0 is in force. When the decode queue 34 has 2 to 14 (inclusive) valid entries, a throttling level/policy 1 is in force. When the decode queue 34 has 15 to 21 (inclusive) valid entries, a throttling level/policy 2 is in force.

Finally, when the decode queue 34 has more than 22 valid entries, throttling level/policy 3 is in force. Note that, theoretically, since it is the policy that changes, it is possible in this example that an increase in the occupancy of the decode queue 34 will actually cause throttling to stop or decrease. In general, however, one would expect the throttling to increase and indeed, any stop or decrease could be counterbalanced by a further small increase in decode queue 34 occupancy having a vastly increased tendency to throttle for an extended time.

In some examples, rather than consider the occupancy of the decode queue as an absolute, it is possible to consider different policies as a percentage. For instance, if the decode queue is up to 25% full then a first policy is in force. From 25% to 50%, a second policy is in force and so on.

In some examples, rather than considering the instantaneous occupancy of, for instance, the decode queue 34, it is possible to consider the average occupancy over a number of cycles such as over 100k cycles. This helps to avoid a situation in which the policy is continually changed.

Also in some examples, in addition to considering the (average) occupancy of, for instance, the decode queue 34, one might also consider a number of speculative instructions that are in-flight to the number of instructions that have been retired (e.g. in the issue circuitry). This gives an indication of the ‘activeness’ of speculative execution and particularly whether numerous instructions are being speculatively executed at any given instant. There are of course a number of ways that these parameters can be combined. For instance, both factors could be considered separately, each with their own thresholds, and a more aggressive (or less aggressive) policy indicated by each metric could be put into effect. In other embodiments, each threshold could be defined by the two parameters. In yet other embodiments, one of the two parameters could ‘nudge’ the other into a more or less aggressive policy as an adjustment. Other methods of combining are of course also possible.

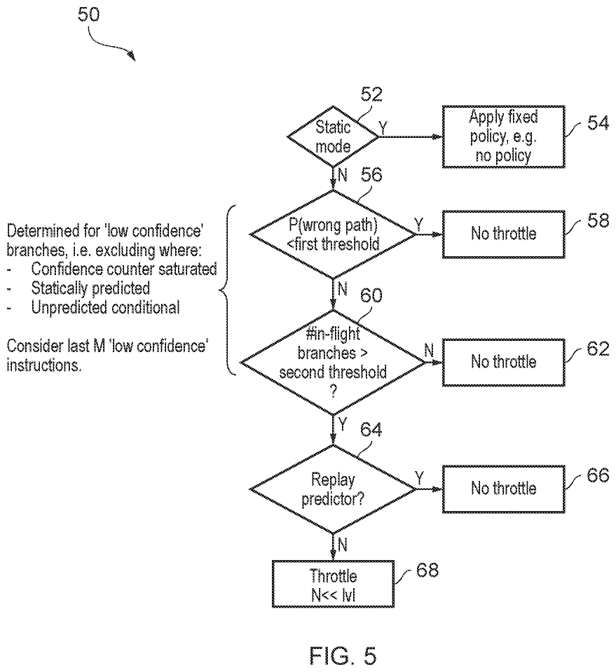

FIG. 5 illustrates a flowchart 50 that shows a method of applying the throttle policy in accordance with some examples. The process starts at a step 52 where it is determined whether the apparatus is operating in a static mode. In the static mode, the throttle circuitry is non-dynamic, which is to say that only a single policy applies. The single policy may indeed not throttle speculation at all. In this situation, if the apparatus is in the static mode then at step 54, the fixed policy is applied. Otherwise at step 56, it is determined whether the probability of a wrong path having been taken is less than a first threshold (e.g. a misprediction threshold). This threshold is determined according to a number of in-flight (unresolved) low confidence branches and the probability that one of those instructions is incorrectly predicted. In other words, this considers all in-flight instructions that could have been mispredicted (N) and the misprediction rate of the last M instructions (α) to give a probability that any of the in-flight conditional non-static control flow instructions has been mispredicted and that a wrong path has therefore been entered onto.

$$P ( wrong path ) = 1 - {( 1 - α )}^{N} = 1 - ( 1 - N α + p {α}^{2} + … ) \approx N α$$

Where p is the coefficient of a binomial series (https://en.wikipedia.org/wiki/Binomial series). If the probability is below the misprediction threshold, then at step 58, no throttling occurs. Otherwise, at step 60, it is determined whether the number of in-flight low confidence branches is greater than a second threshold. If not, then at step 62, no throttling occurs. In other words, throttling does not occur if it is below a de minimis.

Otherwise, at step 64, it is determined whether a replay predictor is in use. If so, then at step 66, no throttling occurs. A replay predictor is a special type of branch predictor that is able to (to some extent) reuse calculations that are performed while on the ‘wrong’ path. Consequently, the cost of misprediction with such a predictor is lower than it might be with other predictors. In recognition of this, the flowchart is less likely to apply throttling. The definition of when a replay predictor is ‘in use’ varies between embodiments. In some examples, it could be that the majority of predictions are made from replay predictors, or that the number of predictions from the replay predictor is above another threshold. In some examples, it could be that a most recent (or least recent) control flow instruction has been predicted using the replay predictor, or that a majority of the current in-flight control flow instructions have previously been predicted using a replay predictor. Other techniques are of course applicable. Additionally, in this example, no throttling is applied. In other examples, the thresholds in steps 56 and 60 might be modified or the level of throttling might be adjusted (e.g. to provide less throttling in the case of a replay predictor being used).

If, at step 64, no replay predictor is in use then at step 68, throttling occurs. The amount of throttling depending on the policy. For instance, a number of dummy entries might be inserted into a part of the pipeline—either for a predefined period or to alter a ratio. In this example, the number of dummy entries is equal to N<<lvl, where again N is the number of in-flight low confidence control flow instructions and lvl is the severity of the throttling (set on a policy-by-policy basis).

Note that the low confidence requirement helps to filter out control flow instructions where there is little (or no) risk of misprediction. Such control flow instructions are of little interest to the present technique since they do not (significantly) alter the likelihood with which misprediction has occurred. Low confidence control flow instructions can be considered to be instructions in which any confidence counter associated with the prediction is not maximum, where the prediction cannot be made statically (e.g. through analysis of the instruction in isolation), and where the control flow instruction is itself is predicted and conditional (as opposed to unpredicted and conditional). This latter requirement means that the instruction is not predicted as always not taken.

The probability of a misprediction is made over the previous M instructions.

Note that in this example, steps 52 and 54 form part of the policies themselves. In practice, this may be dealt with at a higher level such as by the circuitry that enforces the policy rather than being part of the policy itself.

Between policies, the thresholds themselves may differ. For instance, a policy t60_m3_s2 might require that the first threshold (misprediction threshold) be greater than 60% for throttling to become active and for the second threshold (the minimum number of in-flight control flow instructions for the policy to become active) to be 3. Meanwhile, when throttling occurs, it occurs in dependence on the number of in-flight low confidence instructions. For instance, if there are eight in-flight low confidence control flow instructions and the level is 2 (from s2), then the number of dummy entries inserted in 8<<2=32.

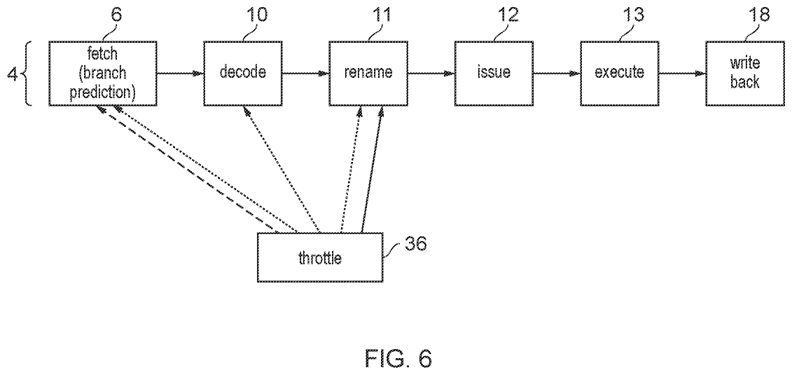

FIG. 6 shows examples of where throttling might take place. FIG. 6 shows the throttle circuitry 36 affecting one or more points of the pipeline 14, which in this example includes a rename stage 11 between the decode stage 10 and the issue stage 12. Here, the throttle circuitry 36 might affect one of the stages 6, 10, 11, 12, 13, 18 or might affect a specific part of one of the stages 6, 10, 11, 12, 13, 18. For instance, the throttle circuitry 36 might affect the branch predictor 40 of the fetch stage 6 so that branch prediction does not occur. This could take place by simply deactivating the branch predictor 40. In some examples, multiple stages of the pipeline 4 are affected such as the fetch 6, decode 10, and rename 11 stages. Again, this could take place by deactivating those portions of the pipeline 4 but this could also take place by inserting dummy entries into the pipeline (such as non-operations NOPS) so that nothing takes place. In some examples, the rename stage 11 in its entirety is deactivated so that renaming does not take place.

By throttling at the rename stage 11, it is possible to progressively increase energy savings as the backpressure created by throttling the rename stage 11 will cause previous stages 6, 10 to throttle. However, until this happens, the fetch stage 6 will continue to perform branch prediction and so the energy savings occur slowly.

By throttling at several stages 6, 10, 11, it is possible to achieve larger energy savings more quickly. However, this can be aggressive and can cause bigger performance penalties.

The middle ground between these two options is to perform throttling at the fetch stage 6, which incorporates the branch prediction process. However, this has a more limited energy saving since only branch prediction is halted or slowed.

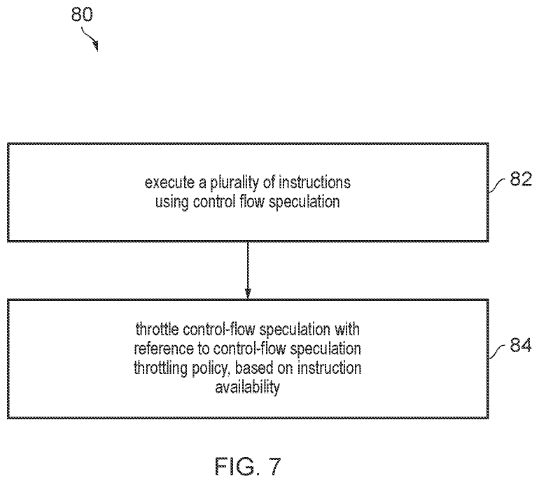

FIG. 7 illustrates a flow chart 80 in accordance with some examples. At a step 82, a plurality of instructions are executed using control flow speculation. At a step 84, the control flow speculation is throttled with respect to an availability of instructions. For instance, this might be determined with reference to the decode queue.

Concepts described herein may be embodied in an apparatus comprising execution circuitry having one or more vector processing units for performing vector operations on vectors comprising multiple data elements. Execution circuitry having X vector processing units each configured to perform vector operations on Y bit wide vectors, with the respective vector processing units operable in parallel, may be said to have an X×Y bit vector datapath. In some embodiments, the execution circuitry is provided having six or more vector processing units. In some embodiments, the execution circuitry is provided having five or fewer vector processing units. In some embodiments, the execution circuitry is provided having two vector processing units (and no more). In some embodiments, the one or more vector processing units are configured to perform vector operations on 128-bit wide vectors. In some embodiments, the execution circuitry has a 2×128 bit vector datapath. Alternatively, in some embodiments the execution circuitry has a 6×128 bit vector datapath.

Concepts described herein may be embodied in an apparatus comprising a level one data (LID) cache. The LID cache is a private cache associated with a given processing element (e.g. a central processing unit (CPU) or graphics processing element (GPU)). In a cache hierarchy of multiple caches capable of caching data accessible by load/store operations processed by the given processing element, the LID cache is a level of cache in the hierarchy which is faster to access than a level two (L2) cache. In some embodiments, the L1 data cache is the fastest to access is the hierarchy, although even faster to access caches, for example, level zero (L0) caches may also be provided. If a load/store operation hits in the LID cache, it can be serviced with lower latency than if it misses in the LID cache and is serviced based on data in a subsequent level of cache or in memory. In some embodiments, the LID cache comprises storage capacity of less than 96 KB, in one example the LID cache is a 64 KB cache. In some embodiments, the LID cache comprises storage capacity of greater than or equal to 96 KB, in one example the LID cache is a 128 KB cache.

Concepts described herein may be embodied in an apparatus comprising a level two (L2) cache. The L2 cache for a given processing element is a level of cache in the cache hierarchy that, among caches capable of holding data accessible to load/store operations, is next fastest to access after the LID cache. The L2 cache can be looked up in response to a load/store operation missing in the LID cache or an instruction fetch missing in an L1 instruction cache. In some embodiments, the L2 cache comprises storage capacity of less than 1536 KB (1.5 MB), in one example the L2 cache is a 1024 KB (1 MB) cache. In some embodiments, the L2 cache comprises storage capacity greater than or equal to 1536 KB and less than 2560 KB (2.5 MB), in one example the L2 cache is a 2048 KB (2 MB) cache. In some embodiments, the L2 cache comprises storage capacity greater than or equal to 2560 KB, in one example the L2 cache is a 3072 KB (3 MB) cache. In some embodiments, the L2 cache has a larger storage capacity than the L1D cache.

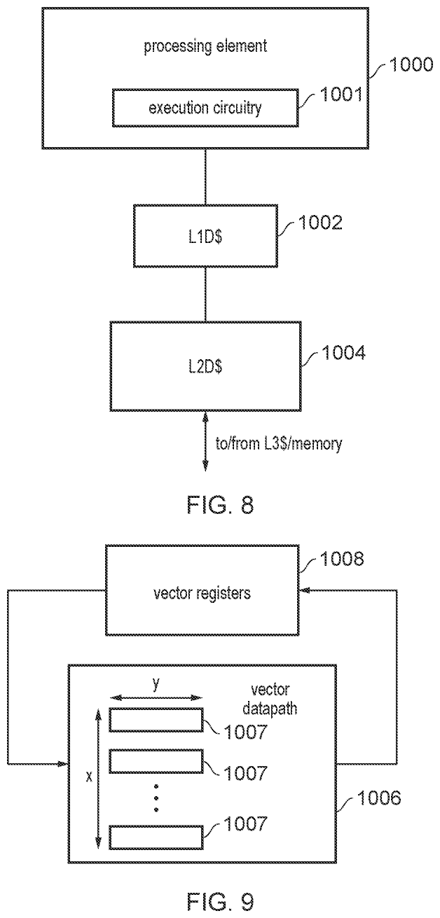

FIG. 8 illustrates an example of an apparatus comprising a processing element 1000 (e.g. a CPU or GPU) comprising execution circuitry 1001 for executing processing operations in response to decoded program instructions. The processing element 1000 has access to a LID cache 1002 and a L2 cache 1004, which are part of a cache hierarchy of multiple caches for caching data from memory that is accessible by the processing element 1000 in response to load/store operations executed by the execution circuitry 1001. The processing element may, for instance, correspond with the pipeline 4, branch predictor 40, table updating circuitry 120, and registers 14 illustrated in FIG. 1, with the execution circuitry 1001 corresponding with the execution unit.

FIG. 9 illustrates an example of a vector datapath 1006 that may be provided as part of the execution circuitry 1001 of the processing element 1000, and vector registers 1008 for storing vector operands for processing by the vector datapath 1006. Vector operands read from the vector registers 1008 are processed by the vector datapath 1006 to generate vector results which may be written back to the vector registers 1008. The vector datapath 1006 is an X×Y bit vector datapath, comprising X vector processing units 1007 each configured to perform vector operations on Y bit vectors. The vector registers 1008 may be accessible as Z bit vector registers, where Z can be equal to Y or different to Y. For a vector operation requiring a Z-bit vector operand where Z is greater than Y, the Z-bit vector operand can be processed using two or more vector processing units 1007 operating in parallel on different portions of the Z-bit vector operand in the same cycle and/or using multiple passes through the vector datapath in two or more cycles. For vector operations requiring a Z-bit vector operand where Z is less than Y, a given vector processing unit 1007 can process two or more vectors in parallel.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL.

Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

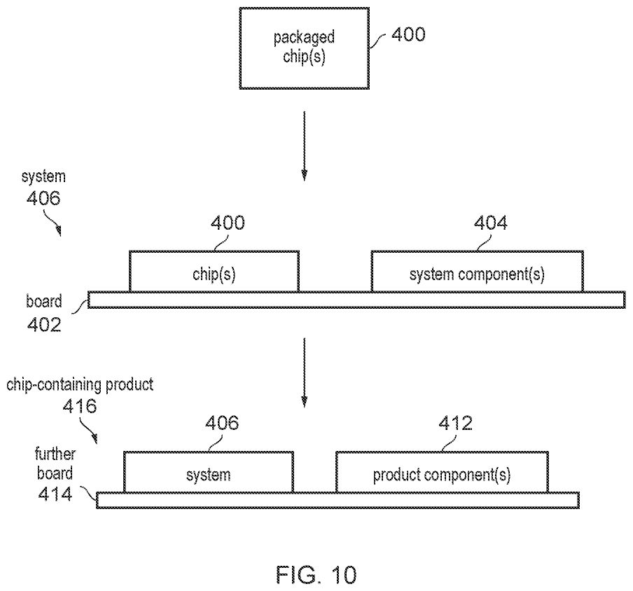

As shown in FIG. 10, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

The present technique could be configured as follows:
1. A data processing apparatus comprising:
   execution circuitry configured to execute a plurality of instructions using speculation; and
   throttle circuitry configured to throttle an extent to which the speculation is performed, wherein
   the throttle circuitry is configured to control throttling speculation based on an availability of the instructions.
2. The data processing apparatus according to any preceding clause, wherein
   the availability of the instructions is determined according to an occupancy of a decode queue by the instructions.
3. The data processing apparatus according to any preceding clause, wherein
   the throttle circuitry is configured to throttle speculation more aggressively when the availability of the instructions is above an availability threshold as compared to when the availability of the instructions is below the availability threshold.
4. The data processing apparatus according to any preceding clause, wherein
   the throttle circuitry is configured to throttle speculation by selection of a speculation throttling policy.
5. The data processing apparatus according to clause 4, wherein
   the speculation throttling policy causes throttling based on an estimated probability that a current in-flight control flow instruction in the instructions has been mispredicted based on a number of in-flight control flow instructions in the instructions and a current prediction success rate of control flow instructions in the instructions.
6. The data processing apparatus according to clause 5, wherein
   the current prediction success rate of control flow instructions in the instructions is the current prediction success rate of low-confidence control flow instructions in the instructions.
7. The data processing apparatus according to clause 6, wherein
   the low confidence control flow instructions comprise those for which the following conditions are met:
   conditional control flow instructions whose confidence metric is unsaturated,
   control flow instructions that are predicted dynamically, and
   conditional control flow instructions that are predicted.
8. The data processing apparatus according to any one of clauses 5-6, wherein
   the speculation throttling policy causes throttling to increase when a likelihood that the current in-flight control flow instruction in the instructions has been mispredicted is above a misprediction threshold.
9. The data processing apparatus according to any one of clauses 1-8, wherein
   the throttle circuitry is configured to throttle the extent to which the speculation is performed by stalling a single point of a pipeline comprising the processing circuitry.
10. The data processing apparatus according to clause 9, wherein
   the single point is a rename stage of the pipeline.
11. The data processing apparatus according to claim 9, wherein
   the single point is a branch prediction stage of the pipeline.
12. The data processing apparatus according to any one of clauses 1-8, wherein
   the throttle circuitry is configured to throttle the extent to which the speculation is performed by stalling multiple points of a pipeline comprising the processing circuitry.
13. The data processing apparatus according to clause 12, wherein
   the multiple points are between a branch prediction stage of the pipeline and a rename stage of the pipeline, inclusive.
14. The data processing apparatus according to any preceding clause, wherein
   the throttle circuitry is configured to throttle speculation additionally based on a type of predictor used for the speculation being performed.
15. The data processing apparatus according to any preceding clause, wherein
   the throttle circuitry is configured to throttle speculation additionally based on an extent to which a replay predictor is used for the speculation.
16. The data processing apparatus according to any preceding clause, comprising:
   control circuitry configured to selectively control the throttle circuitry to enter a static mode of operation in which the throttle circuitry is configured to control throttling speculation regardless of the availability of the instructions.
17. The data processing apparatus of any one of clauses 1-16, wherein
   the execution circuitry comprises a 6×128 bit vector datapath.
18. The data processing apparatus of any one of clauses 1-17, wherein
   the throttle circuitry is configured to control throttling speculation additionally based on a number of the instructions that have been executed speculatively divided by a number of retired instructions.
19. A method comprising:
   executing a plurality of instructions using speculation; and
   controlling throttling of speculation, wherein
   the controlling is based on an availability of the instructions.
20. A non-transitory computer-readable medium storing computer-readable code for fabrication of a data processing apparatus comprising:
   execution circuitry configured to execute a plurality of instructions using speculation; and
   throttle circuitry configured to throttle an extent to which the speculation is performed, wherein
   the throttle circuitry is configured to control throttling speculation based on an availability of the instructions.
21. A system comprising:
   the data processing apparatus of any one of clauses 1-18, implemented in at least one packaged chip;
   at least one system component; and
   a board, wherein
   the at least one packaged chip and the at least one system component are assembled on the board.
22. A chip-containing product comprising the system of clause 21, wherein the system is assembled on a further board with at least one other product component.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. A data processing apparatus comprising:
execution circuitry configured to execute a plurality of instructions using speculation; and
throttle circuitry configured to throttle an extent to which the speculation is performed, wherein
the throttle circuitry is configured to control throttling speculation based on an availability of the instructions.

2. The data processing apparatus according to claim 1, wherein
the availability of the instructions is determined according to an occupancy of a decode queue by the instructions.

3. The data processing apparatus according to claim 1, wherein
the throttle circuitry is configured to throttle speculation more aggressively when the availability of the instructions is above an availability threshold as compared to when the availability of the instructions is below the availability threshold.

4. The data processing apparatus according to claim 1, wherein
the throttle circuitry is configured to throttle speculation by selection of a speculation throttling policy.

5. The data processing apparatus according to claim 4, wherein
the speculation throttling policy causes throttling based on an estimated probability that a current in-flight control flow instruction in the instructions has been mispredicted based on a number of in-flight control flow instructions in the instructions and a current prediction success rate of control flow instructions in the instructions.

6. The data processing apparatus according to claim 5, wherein
the current prediction success rate of control flow instructions in the instructions is the current prediction success rate of low-confidence control flow instructions in the instructions.

7. The data processing apparatus according to claim 6, wherein
the low confidence control flow instructions comprise those for which the following conditions are met:
conditional control flow instructions whose confidence metric is unsaturated,
control flow instructions that are predicted dynamically, and
conditional control flow instructions that are predicted.

8. The data processing apparatus according to claim 5, wherein
the speculation throttling policy causes throttling to increase when a likelihood that the current in-flight control flow instruction in the instructions has been mispredicted is above a misprediction threshold.

9. The data processing apparatus according to claim 1, wherein
the throttle circuitry is configured to throttle the extent to which the speculation is performed by stalling a single point of a pipeline comprising the processing circuitry.

10. The data processing apparatus according to claim 9, wherein
the single point is a rename stage of the pipeline.

11. The data processing apparatus according to claim 9, wherein
the single point is a branch prediction stage of the pipeline.

12. The data processing apparatus according to claim 1, wherein
the throttle circuitry is configured to throttle the extent to which the speculation is performed by stalling multiple points of a pipeline comprising the processing circuitry.

13. The data processing apparatus according to claim 12, wherein
the multiple points are between a branch prediction stage of the pipeline and a rename stage of the pipeline, inclusive.

14. The data processing apparatus according to claim 1, wherein
the throttle circuitry is configured to throttle speculation additionally based on a type of predictor used for the speculation being performed.

15. The data processing apparatus according to claim 1, comprising:
control circuitry configured to selectively control the throttle circuitry to enter a static mode of operation in which the throttle circuitry is configured to control throttling speculation regardless of the availability of the instructions.

16. The data processing apparatus of claim 1, wherein
the execution circuitry comprises a 6×128 bit vector datapath.

17. A method comprising:
executing a plurality of instructions using speculation; and
controlling throttling of speculation, wherein
the controlling is based on an availability of the instructions.

18. A non-transitory computer-readable medium storing computer-readable code for fabrication of a data processing apparatus comprising:
execution circuitry configured to execute a plurality of instructions using speculation; and
throttle circuitry configured to throttle an extent to which the speculation is performed, wherein
the throttle circuitry is configured to control throttling speculation based on an availability of the instructions.

19. A system comprising:
the data processing apparatus of claim 1, implemented in at least one packaged chip;
at least one system component; and
a board, wherein
the at least one packaged chip and the at least one system component are assembled on the board.

20. A chip-containing product comprising the system of claim 19, wherein the system is assembled on a further board with at least one other product component.
